(19) United States
(12) Patent Application Publication
(10) Pub. No.: US 2006/0010049 A1
(43) Pub. Date: Jan. 12, 2006

(54) Regulatory auditing methods and systems

(75) Inventor: Virginia M. Sunde, Charlotte, NC (US)

Correspondence Address: BAKER & HOSTETLER LLP;Washington Square, Suite 1100, 1050 Connecticut Avenue, N.W., Washington, DC, 20036, US

(73) Assignee: SPX Corporation

(21) Appl. No.: 10/857,928

(22) Filed: Jun. 2, 2004

(51) Int. Cl. G06F 17/60

(52) U.S. Cl. 705/30

(57) ABSTRACT

Techniques for conducting a regulatory audit are described. A computerized audit-administrator is coupled to one or more terminals located at various sites via a network, such as the Internet. Accordingly, the audit-administrator can coordinate a regulatory audit having one or more questionnaires to one or more operators located at the terminals.

### FIELD OF THE INVENTION

This invention relates to methods and systems for conducting audits using a networked tool.

### BACKGROUND OF THE INVENTION

Government-imposed regulation is not a new concept by any means. However, the historically recent explosions of technology, industrialization and urban development have spawned the need for seemingly endless reams of new and complex regulations.

Whether a particular set of regulations are designed to protect worker safety, ensure the quality of the food supply, contain pollution and so on, the sheer quantity and complexity of regulations has made regulatory auditing extremely problematic due to the difficulty of tracking changes in the evolving regulatory standards and measuring compliance with these standards.

Despite these problems, the pool of computer-based tools available to address regulatory auditing is spartan at best, with the best of such tools being limited to software packages that must be installed onto a first computer before an audit-administrator can design an audit, then installed on a second machine before someone can actually reply to such audits. Accordingly, new methods and systems directed to conducting regulatory audits are desirable.

### SUMMARY OF THE INVENTION

The advantages of using the disclosed methods and systems are notable not just for their apparent utility, but also because they transcend any other known approach which uses computers to solve regulatory auditing issues. Indeed, history shows that certain forms of government regulations have been around for millennia, communications networks have been around for over a century, the Internet with its predecessors have been around for over thirty years, computer-based auditing tools have been around for decades, and so on, yet no one has attempted a noteworthy approach to regulatory auditing. That is, despite the fact that both the problems and the basic technology were publicly known for decades, no one had previously conceived and assembled the various disclosed methods and systems in such a way to create a comparable auditing tool.

In a variety of embodiments, an apparatus, method and software product are described that are useful for conducting a regulatory audit. The respective method can include a computerized administrator coupled to one or more terminals via a network, such as the internet, where the administrator is configured to administer a regulatory audit having one or more questionnaires to one or more operators located at geographically distant sites from one another.

Such questionnaires can include any number of features never before applied to auditing, such as a control enabling individual operators to respond using any number of available language selections, the ability to apply default settings to whole sections of a questionnaire using a single selection, the ability to answer questions by electronically importing data from a previous questionnaire and the ability to incorporate any number of independent files into a response, such a spreadsheet file, a database file, a multimedia file, an audio recording, a movie file and a still photograph file.

Further, the methods and systems are configured to raise flags based on a particular answer submitted to a questionnaire or a failure to answer a particular question, and action plans can be automatically administered. Communications between various operators and administrators can be facilitated and reports can be generated.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram depicting a networked-system capable of administering a regulatory audit.

FIG. 2 is a block diagram depicting an exemplary client-site.

FIG. 3 is a block diagram depicting an exemplary audit-administrator.

FIG. 4 depicts a first exemplary web-page generated by the audit-administrator of FIG. 3.

FIGS. 5A-7B depict various abilities of the exemplary audit-administrator of FIG. 3.

FIG. 8 depicts a report-generation capacity of the exemplary audit-administrator of FIG. 3.

FIG. 9 is a flowchart outlining a first exemplary operation.

FIG. 10 is a flowchart outlining a second exemplary operation.

### DETAILED DESCRIPTION

As mentioned above, the available pool of computer-based tools useful for conducting regulatory audits is Spartan at best despite the ever-growing mountains of regulations. Accordingly, the inventors of the methods and systems described below have responded by developing a novel, network-based auditing tool containing a wide variety of new features such that the managers of various enterprises, e.g., power plants, industrial production facilities and so on, can more easily and accurately comply with such regulations and other restrictions placed upon them.

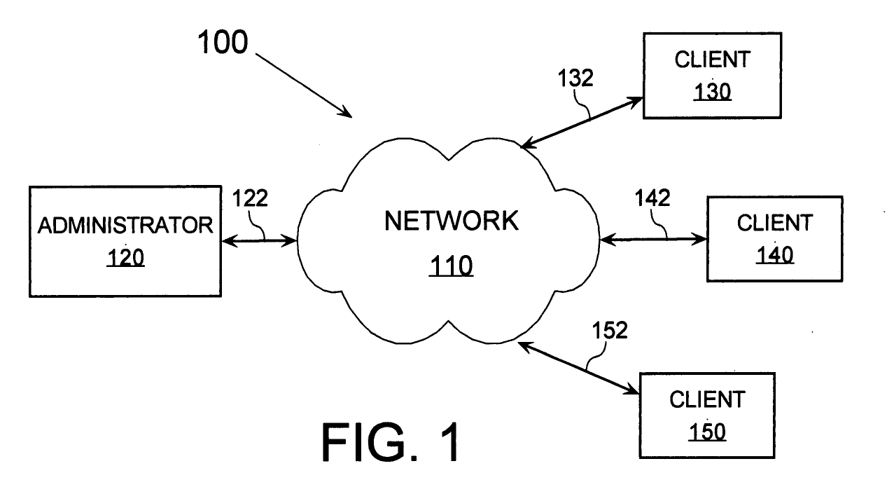

FIG. 1 depicts an exemplary networked-system 100 configured to enable the development, distribution and coordinated completion of audits. As shown in FIG. 1, the networked-system 100 includes an administrator-site 120 coupled to a network 110 via link 120, and a number of client-sites 130, 140 and 150 coupled to the network 100 via respective links 132, 142 and 152.

In operation, a number of audit-administrators at the administrator-site 120 can first develop an number of questionnaires designed to conduct an audit. In the present embodiment, the administrator-site 120 (with its various novel features) is particularly useful for developing questionnaires directed to complying with an environmental audit. However, while the administrator-site 120 can be used for environmental audits, it should be appreciated that the administrator-site 120 is useful for questionnaires in general and particularly useful for regulatory audits where the sheer mass of regulations is appreciable.

For instance, some particularly good examples of such regulations can be found in the various titles of the United States Code of Federal Regulations, such as workplace safety, energy, transportation, accounting, banking, internal revenue, mineral resources, emergency management and assistance, commercial practices, commerce and foreign trade, elections, commodity and securities exchanges, employees benefits, homeland security, national defense and agriculture. Appropriate regulations also can be found in the various rules promulgated by a government bureaucracies, the various standards promulgated by commercial standards-making bodies, e.g., the International Telecommunications Union, or in any other situation where regulatory compliance is necessary or desirable.

Returning to FIG. 1, once the audit-administrators have developed the appropriate questionnaires, such questionnaires can be appropriately formatted and enhanced with a number of useful features as will be discussed below. In order to appropriately format the questionnaires and enable various features, the questionnaires of the present embodiment can take the form of a number of web-pages formatted using HTML, XML, Flash or any other viable publishing standard, such that people answering such questionnaires can do so using nothing more than a commercially available web-browser. However, it also should be appreciated that the questionnaires also can take form of any number of specially designed software packages as may be necessary or otherwise desired under a set of particular circumstances.

After the questionnaires are prepared and formatted, the audit-administrators can send an initial message to the appropriate parties that a questionnaire is available and should be attended. Additionally, the audit-administrators can post the questionnaires, i.e., configure the administrator-site 120 to make such questionnaires available to the appropriate client-sites 130-150 via the network 110.

In response, the operators at the various client-sites 130-150 can respond to the questionnaires by directly answering individual questions and/or by using any of the novel features disclosed below. One of the unique features of the disclosed methods and systems is the ability of an audit-administrator to both structure a set of questionnaires in such a way as to coordinate actions between a number of facilities and to facilitate cooperation. For example, suppose that a corporation owns a dozen coal-fired power plants having varying clean-air technologies, and the corporation's auditors wish to make sure that each plant complies with the federally mandated maximum allowed air-emissions discharge over the last quarter. Using the present system, an audit-administrator could design a question such that, if an operator at a particular plant responded that his plant exceeded the allowed pollution limit, a “flag”, i.e. a logical indicator signifying that special attention is required, can be raise.

For instance, assuming that two of the twelve plants in the example above exceed their allowed air-emission limits, two separate flags could be automatically raised. In response to the flags, the present methods and systems can optionally impose an “action plan” to address each of the flags. With regard to the power-plant hypothetical, such an action plan might include such steps as: determining whether the corporation can cover the two plants' excesses with pollution credits from it's other plants, determining whether the corporation is able to buy pollution credits on the open market, determining whether there are technical malfunctions in the air-cleaning equipment, ascertain the available types (and respective costs) of air-cleaning upgrades that are available and making a decision whether to buy pollution credits or invest in new air-cleaning equipment.

In view of the hypothetical above, it should be appreciated that communication can greatly aid in the quick resolution of problems—such communication including communication between various operators and audit-administrators, communication between different operators at different plants, communication between the auditors/operators and certain designated third-parties, such as the corporations' management and purchasing agents, etc.

In order to facilitate communication, the present methods and systems envision incorporating any number of communication systems. For example, in the present embodiment a particular flag may automatically cause messages to be sent over an existing email system while further causing special indicators, e.g., “pop-ups”, to manifest themselves on an operator/administrator's screen. However, in other embodiments automatic voicemail messages can be generated, special voice-over-IP messages can be facilitated between operators and administrators, teleconferences can be automatically arranged or any other number of communications paradigms can be used as may be convenient, necessary or otherwise preferred.

Once the various questionnaires have been sufficiently answered and flags and action plans sufficiently resolved, the gathered data can be compiled and the appropriate audit reports generated.

The exemplary administrator-site 120 is a computer-based server capable of accessing the Internet. However, it should be appreciated that the administrator-site 120 can take any number of forms, including a server, a personal computer, a mainframe etc. While administrative facilities, such the exemplary administrator-site 120, generally are expected to be located at a management facility, such as a corporate headquarters, the exemplary administrator-site 120 can be located practically anywhere, including a location within one of the client-sites 130-150.

The client-sites 130-150 of the immediate example can include a variety of industrial facilities, such as power-plants, chemical plants, food-processing plants and manufacturing facilities that are subject to environmental regulation and audits. However, it should be appreciated that the nature of the client-sites 130-150, as well as the nature of the audits and type of regulation involved, can vary across a wide spectrum of activities.

Depending on the nature of the regulation, the client-sites 130-150 may be located at geographically distant locations, While the phrase “geographically distant locations” and its derivative terms are somewhat imprecise in nature, such terms generally refer to two or more sites/locations that are not within the same building or complex of buildings. For the purpose of this disclosure, it should be appreciated that geographically distant sites may refer to locations separated by a few city blocks or my several miles, locations separated by state or national boundaries or even perhaps even refer to locations separated by regulatory boundaries, i.e., locations where different standards of regulations may apply.

The exemplary network 110 is a Virtual Private Network (VPN) resident on a portion of the Internet. However, in other embodiments the network 110 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 122, 132, 142 and 152 of the present embodiment are a combination of devices and software/firmware configured to couple computer-based systems to the Internet over a wired line. However, it should be appreciated that in differing embodiments the links 122, 132, 142 and 152 can take the forms of modems, networks interface card, serial buses, parallel busses, WAN or LAN interfaces, wireless or optical interfaces and the like as may be desired or otherwise dictated by design choice.

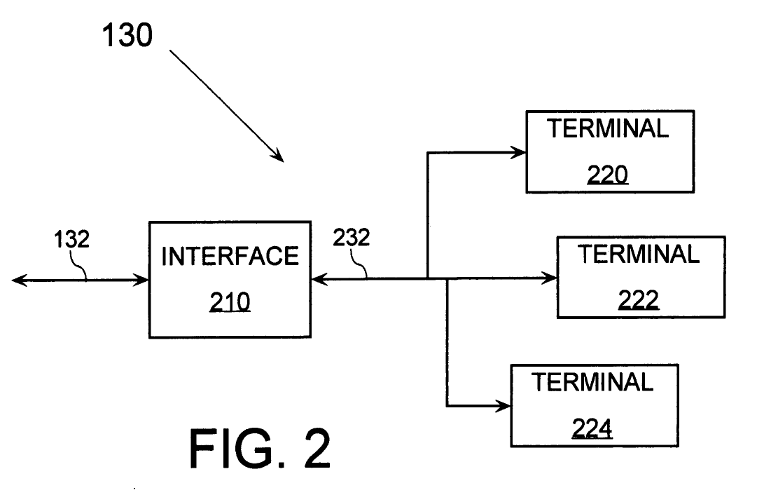

FIG. 2 is an exemplary client-site 130 according to the disclosed methods and systems. As shown in FIG. 2, the exemplary client-site 130 includes an interface 210 coupled to a number of terminals 220-224 via link 232, and further coupled to an external network (not shown) via link 132.

In operation, various operators using their respective terminals 220-224 can communicate with an audit-administrator as required to complete a given audit. For example, a first questionnaire can be administered to a first operator at the first terminal 220, and a second questionnaire can be administered jointly to two other operators using terminals 222 and 224. Accordingly, it should be appreciated that, in various instances a single questionnaire may serve multiple sites, while in other instances questionnaires may be customized to individual sites and even individual operators.

The exemplary terminals 220-224 can be personal computers executing transmission control protocol (TCP) operating over Internet protocol (IP), commonly referred to as TCP/IP. However, the terminals 220-224 can also be any one of a number of different types of devices, such as a computer, a server, a PDA, a voice-responsive terminal or any combination of software or hardware capable of enabling an operator to communicate with a computerized system.

The interface 210 can be a computer based server with specialized interfaces capable of interfacing an external network with the various terminals 220-224. However, it should be appreciated the interface 210 can be any known or later developed combination of systems and devices as desired or otherwise required to facilitate communication between a terminal and an external computer-based device.

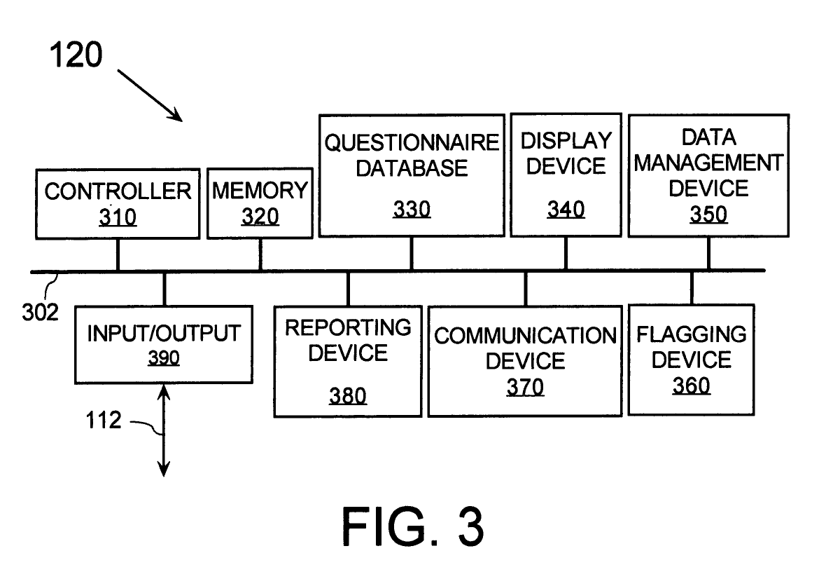

FIG. 3 is an exemplary audit-administrator 120 according to the disclosed methods and systems. As shown in FIG. 3, the exemplary audit-administrator 120 includes a controller 310, a memory 320, a questionnaire database 330, a display device 340, a data management device 350, a flagging device 360, a communication device 370 a reporting device 380 and an input/output device 390. The above components 310-390 are coupled together by control/data bus 302. Although the audit-administrator 120 uses a bussed architecture, it should be appreciated that any other architecture may be used as is well known to those of ordinary skill in the art. Further, it should be appreciated some of the above-listed components can take the form of software/firmware routines residing in memory 320 and executed by the controller 310.

In operation an operator using the audit-administrator 120 can develop a number of questionnaires, such as questionnaires related to a regulatory audit, and store them in the questionnaire database 330. Subsequently, the operator can send an initial message to the various parties responsible for answering (and monitoring the answering of) the questionnaire via the communication device 370 and input/output device 390.

Next, as various parties evoke their respective questionnaires, the display device 340 can access the appropriate questionnaires, format them and subsequently cause them to be displayed on a remote terminal, such as those terminals shown in FIG. 2.

As mentioned above, the display device 340 can offer an operator a number of conveniences to an operator. In the present embodiment, such conveniences include controls that enable questionnaires to be displayed in a desired language. Other conveniences include a number of functional controls, such as a specialized control that can enable an operator to attach (or otherwise incorporate) various independent files, such as databases, spreadsheets, multimedia files etc, into his answers.

During operation, as the various questions within the questionnaires are answered, the data management device 350 can monitor and store the responses and various incorporated files. Should the data management device 350 detect certain anomalies, e.g., errant answers, inconsistent answers from different operators, answers outside allowable bounds or the failure of an operator to provide (or timely provide) an answer to a required question, the data management device 350 can send a signal to the flagging device 360. The flagging device 360, in turn, subsequently can generate a flag/alert, send a number of appropriate messages via the communication device 370 and initiate an action plan.

Also as mentioned above, an action plan can be a plan that includes a number of specific steps necessary to resolve an issue. However, it should be appreciated that action plans can take many forms and be process-oriented, goal-oriented or otherwise take any form useful for a set of particular circumstances.

Still further, it should be appreciated that while a particular action plan can take a particular, rigid form, in various embodiments and circumstances action plans can take the form of a malleable set of instructions. For instance, using the air-emissions example above, it may desirable for an action plan to start with a single first step, i.e., determining whether two plants' emissions excesses can be covered using emissions credits from it's other ten plants, based on a history of this single step working well for the exemplary corporation. However, the exemplary corporation may be best served by abrogating this first step by undertaking a study as to the cost of buying newly developed air-cleaning upgrades for its errant plants and then selling its own air-emission credits on the open market.

Once the various flags/action plans are resolved and all necessary data collected, an operator can send a command to the reporting device 380 to automatically generate (or aid in the generation of) an appropriate report, which can take any number of forms, including a form suitable for paper as well as an electronic form having optional electronic controls useful to evoke spreadsheets, multimedia files etc.

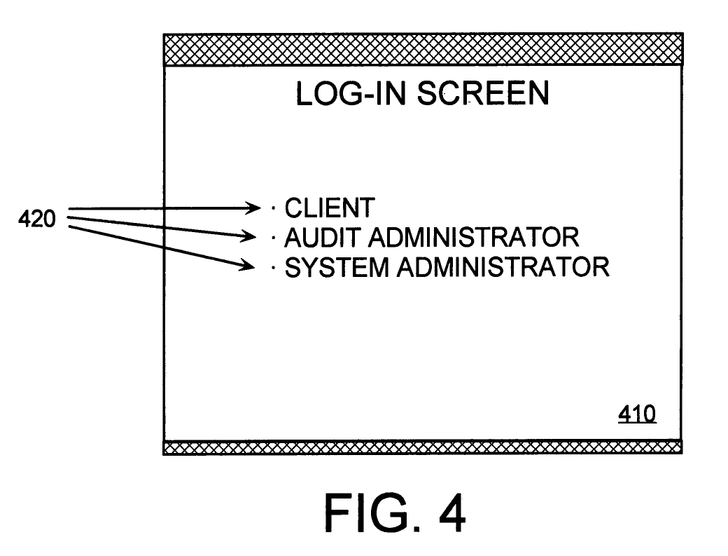

FIG. 4 is an exemplary log-in web-page 410 useful for accessing an audit system. As shown in FIG. 4, the log-in web-page 410 includes three options 420, the first of which can enable an operator at a client-site to access one or more questionnaires, the second of which can enable an audit-administrator to form and monitor questionnaires and the third to enable a system administrator to service the system and upgrade software.

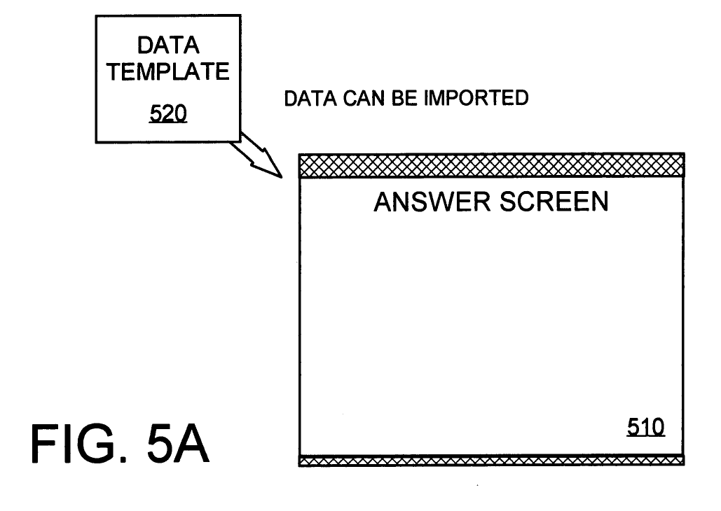

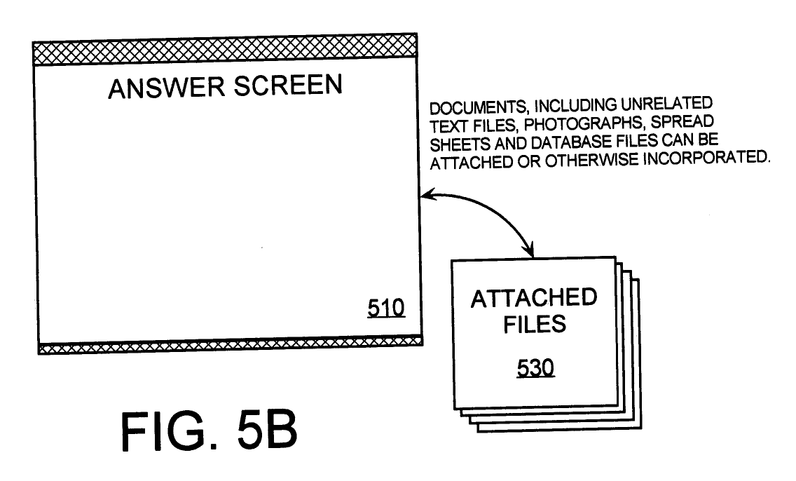

FIG. 5A depicts a first exemplary operation useful for responding to an audit. As depicted in FIG. 5A, an operator using a first answer web-page 510 can import data from an external data-template 520 in order to fill in the various answers. The exemplary data-template 520 is derived from a previously administered questionnaire, and the process depicted in FIG. 5A is derived under the assumption that the present questionnaire may have many answers in common with those of a previously administered questionnaire. However, it should be appreciated that the particular origins and form of the data-template 520 can vary as desired or otherwise required for a given audit. Once the answers from the data-template 520 are imported, an operator can optionally overwrite or otherwise alter the template answers as necessary.

FIG. 5B depicts a second exemplary operation useful for responding to an audit. As depicted in FIG. 5B, an operator using the first answer web-page 510 can attach or otherwise incorporate any number of independent files 530 including database files, spreadsheets etc. An advantage to this approach is that it allows an audit to incorporate any number of existing databases, spreadsheets and media without expending the excessive effort otherwise required to incorporate the underlying data.

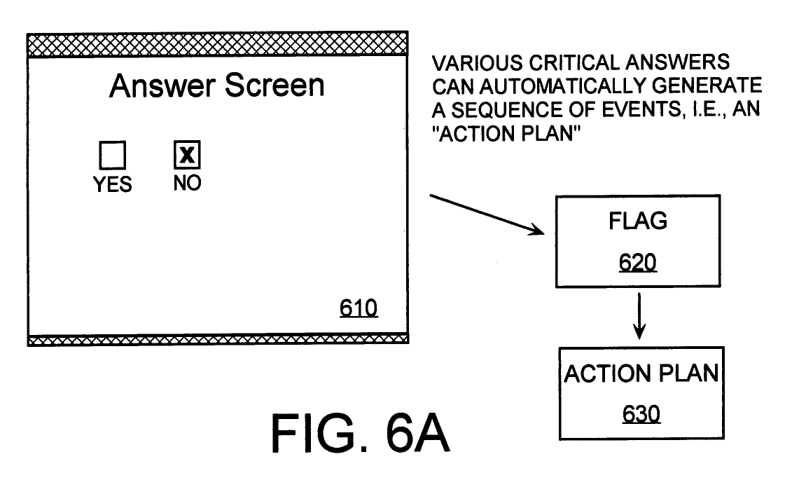

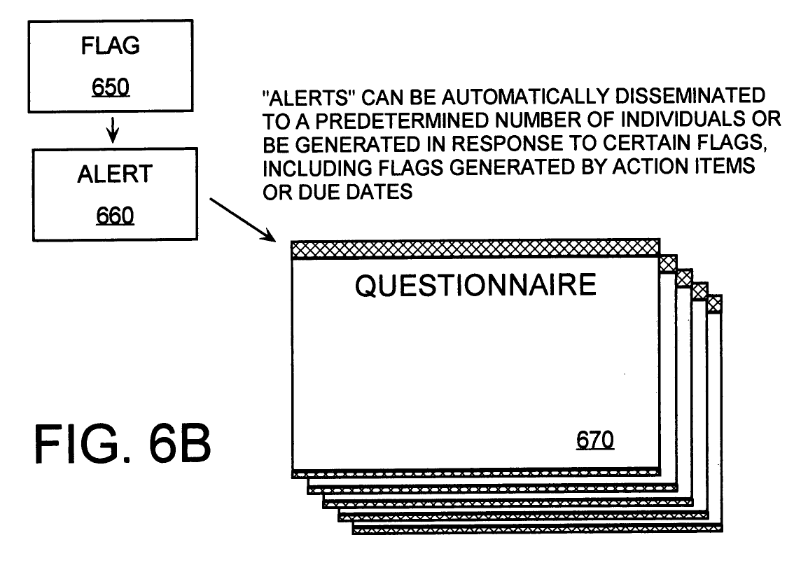

FIG. 6A depicts a third exemplary operation useful for responding to an audit. As depicted in FIG. 6A, an operator using answer web-page 610 can enter an answer that, in the present circumstances, causes a flag 620 to be raise and an action plan 630 to be evoked. FIG. 6B depicts a fourth exemplary operation useful for responding to an audit. As depicted in FIG. 6B, a flag 650, in addition to evoking an action plan, can generate an independent alert 660 to a predetermined set of individuals. Such alerts can take the form of email messages, messages displayed on questionnaire pages 670, highlighted sections in pages 670 and so on.

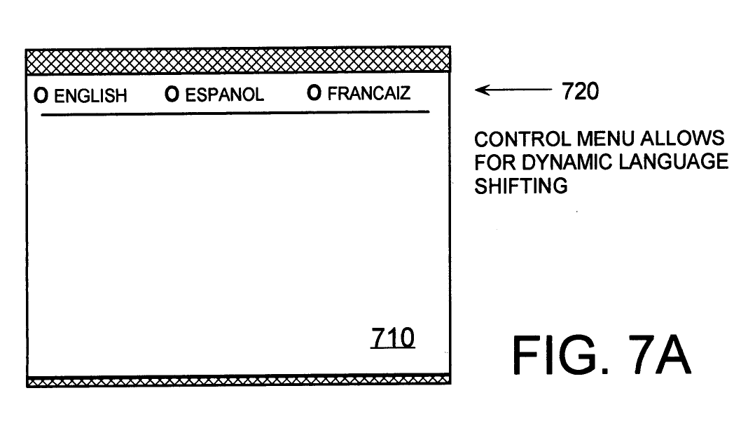

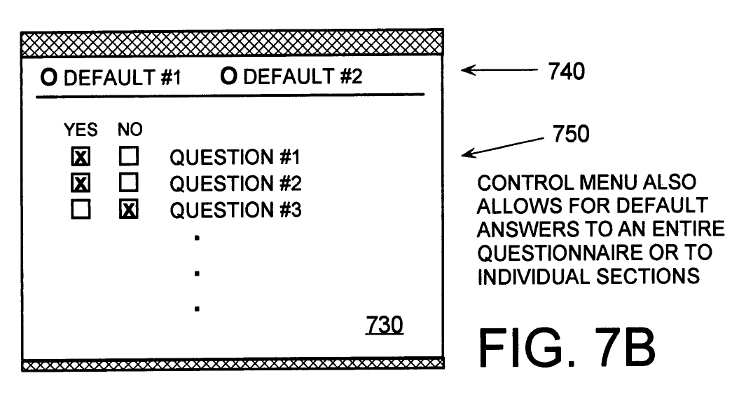

FIG. 7A depicts a fifth exemplary operation useful for responding to an audit. As depicted in FIG. 7A, an operator using answer web-page 710 can activate one of a number of language controls 720, which can cause the questionnaire, in whole or in part, to be presented in a particular language.

FIG. 7B depicts a sixth exemplary operation useful for responding to an audit. As depicted in FIG. 7B, an operator using answer web-page 730 can activate any of an available number of default controls 740, which can result in whole sections of the audit to be answered according to a predetermined scheme. For example, in a particular audit an operator may wish to indicate that his facility has had no major equipment breakdowns without making a hundred separate responses. By selecting an “all's well” default button, the operator can accurately respond to the questionnaire in a fraction of the time it would take to answer all of the individual questions.

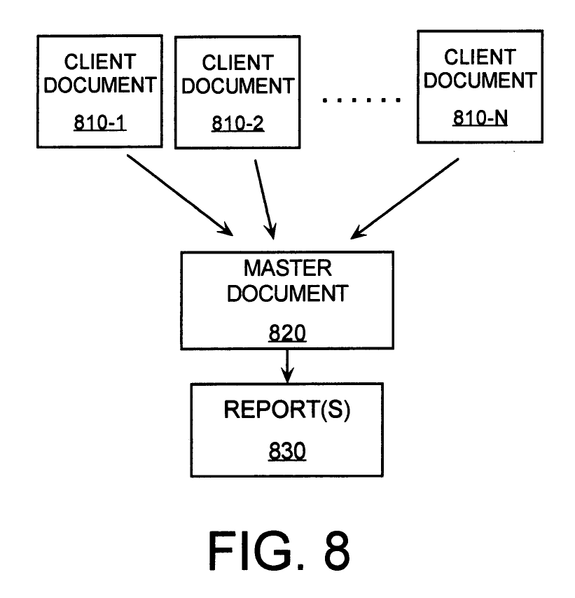

FIG. 8 depicts an exemplary operation where data is compiled and a report generated. As shown in FIG. 8, a number of client-documents 810-1 to 810-N, which can include answered questionnaires with various attached/incorporated files, can be compiled to form a single master document 820 which, in turn, can be used to derive a number of reports 830.

For instance, using the air-emissions scenario discussed above, the exemplary corporation can compile a number of client-documents, e.g., air-emissions reports for each of it plants, and compile the data into a single master document, which can be a database containing a detailed list of the types and quantities of air-emissions for all plants. From this master emissions document, the corporation can generate a number of documents including an official EPA report, a presentation for corporate management and a spreadsheet useful to environmental engineers to make suggestions.

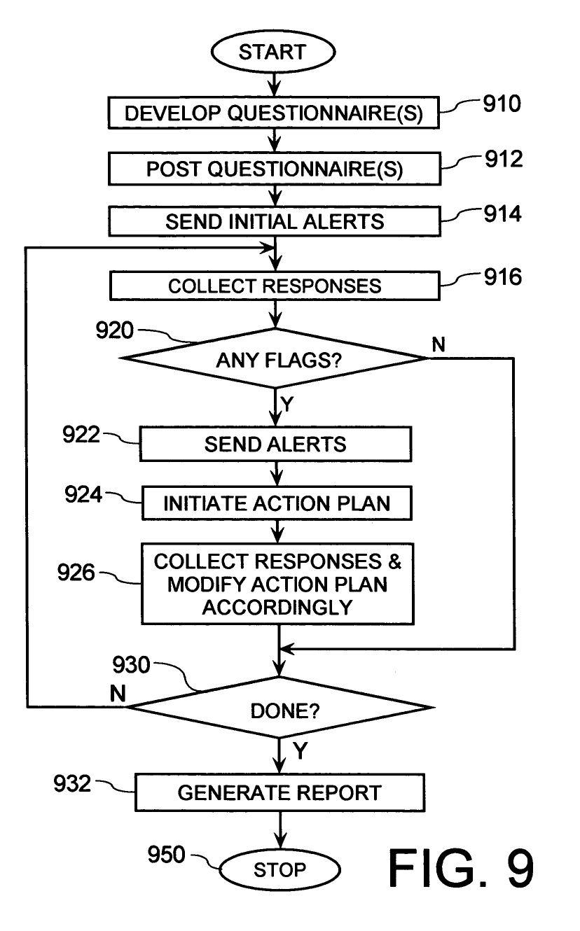

FIG. 9 is a flowchart outlining an exemplary operation according to the present disclosure for performing an audit. The process starts at step 910 where a number of questionnaires can be developed for a particular audit. Next, in step 912, the questionnaires can be “posted”, i.e., made available to the appropriate personnel at any number of geographic sites. Then, in step 914, an initial message can be sent to the appropriate personnel to alert them that an audit is to be performed and questionnaires are available to be answered. Control continues to step 916.

In step 916, responses are collected. Then in step 920, a determination is made as to whether any flags are generated. If any flags are generated, control continues to step 922; otherwise, control jumps to step 930.

In step 922, which assumes one or more flags were generated, a like-number of alerts are sent to the appropriate parties. Next, in step 924, suitable action plans are initiated, and further responses are collected in step 926 until the flags/action plans are resolved. As discussed above, while an action plan may consists of a set of rigid instructions, it may be necessary in various circumstances to incorporate a flexible action plan. Accordingly, step 926 may take the form of a series of queries and responses interleaved by constant modifications to the action plan based on previously provided responses. Control continues to step 930.

In step 930, a determination is made as to whether the data collection portion of the audit is complete. If data collection is complete, control continues to step 932; otherwise, control jumps back to step 916 where more responses are collected.

In step 932, the appropriate audit reports are generated, and control continues to step 950 where the process stops.

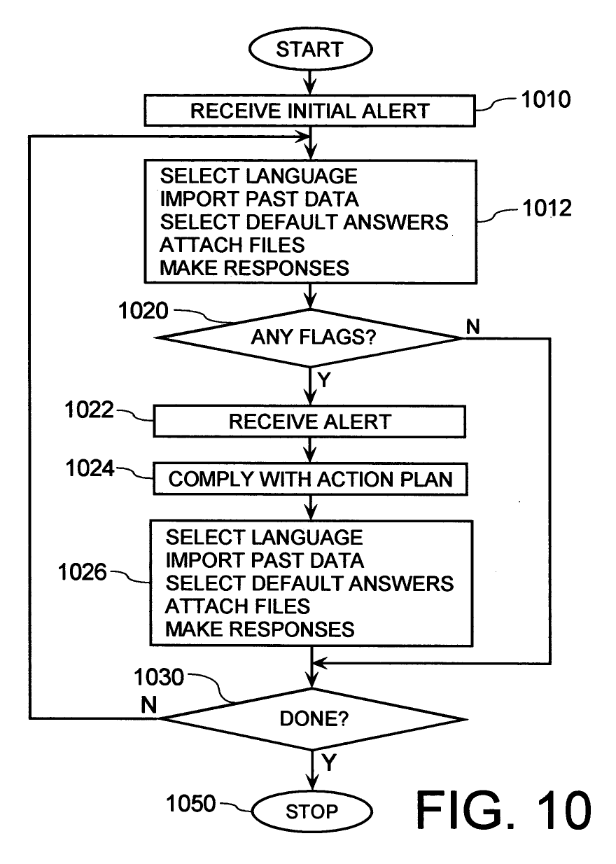

FIG. 10 is a flowchart outlining a second exemplary operation according to the present disclosure for performing an audit from the viewpoint of an operator at a client site. The process starts at step 1010 where an initial alert is received by an operator from an audit-administrator. Next, in step 1012, the operator can perform any number of operations useful to respond to a questionnaire, including selecting a preferred language, importing past data, selecting default answers, attaching/incorporating independent files, responding to individual questions and so on. Control continues to step 1020.

Then in step 1020, a determination is made as to whether any flags are generated. If any flags are generated, control continues to step 1022; otherwise, control jumps to step 1030.

In step 1022, which assumes one or more flags were generated, alerts are received by the appropriate parties. Next, in step 1024, the appropriate action plans are initiated, and further responses are collected in step 1026 until the flags/action plans of step 1024 are resolved. Control continues to step 1030.

In step 1030, a determination is made as to whether the data collection portion of the audit is complete. If data collection is done, control continues to step 1050 where the process stops; otherwise, control jumps back to step 1012 where more responses are collected.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods to conduct audits.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for conducting a regulatory audit, comprising:
a computerized administrator coupled to one or more terminals via a network;
wherein the computerized administrator is configured to administer a regulatory audit having one or more questionnaires to one or more operators using one of the terminals.

2. The apparatus of claim 1, wherein the computerized administrator administers the one or more questionnaires using one or more web-pages, wherein the network is a portion of the internet, and wherein the terminal uses a web-browser to display the web-pages.

3. The apparatus of claim 1, wherein the regulatory audit is directed toward one of environmental regulation.

4. The apparatus of claim 1, wherein the regulatory audit is directed toward a titled subject of the Code of Federal Regulations.

5. The apparatus of claim 4, wherein the regulatory audit is directed toward at least one of workplace safety, energy, accounting, banking, internal revenue, mineral resources, emergency management and assistance, commercial practices, commerce and foreign trade, elections, commodity and securities exchanges, employees benefits, homeland security, national defense and agriculture.

6. The apparatus of claim 2, wherein at least one questionnaire includes a control enabling each operator responding to the questionnaire to respond using a language selected by the operator.

7. The apparatus of claim 2, wherein at least one questionnaire includes a control capable of loading a set of default answers into a section of the questionnaire.

8. The apparatus of claim 2, wherein the computerized administrator is configured to allow an operator to respond to a questionnaire by electronically importing data from a previous audit.

9. The apparatus of claim 2, wherein the computerized administrator is configured to allow an operator to incorporate independent files into a questionnaire.

10. The apparatus of claim 9, wherein at least one incorporated file is one of a spreadsheet, a database, a multimedia file, an audio recording, a movie file and a still photograph file.

11. The apparatus of claim 2, wherein the computerized administrator is configured to generate a flag based on a particular answer submitted to a questionnaire or a failure to answer a particular question.

12. The apparatus of claim 11, wherein the computerized administrator is further configured to administer an action plan based on the generated flag.

13. The apparatus of claim 2, wherein the computerized administrator includes a communication device capable of coordinating communication between a plurality of operators.

14. The apparatus of claim 2, wherein the computerized administrator is configured to administer one or more questionnaires to operators at a plurality of terminals, the terminals being located at sites geographically distant from one another.

15. The apparatus of claim 14, wherein the computerized administrator is also configured to administer one or more questionnaires to a plurality of operators located at a common geographic site.

16. The apparatus of claim 10, wherein the computerized administrator includes a report generator configured to automatically generate a report based on answers provided by each of the plurality of operator.

17. The apparatus of claim 16, wherein the generated report includes a number of electronic pages having a number of electronic controls accessible to a user, the electronic controls being configured to provide access to the independent files.

18. The apparatus of claim 16, wherein the generated report includes an indicator signifying non-compliance with at least one regulation.

19. An apparatus for conducting a regulatory audit, comprising:
a database of one or more questionnaires directed to a regulatory audit; and
a display device capable of presenting the questionnaires to a plurality of operators authorized to access the questionnaires, the operators being located at sites geographically distant from one another.

20. The apparatus of claim 19, wherein the computerized administrator further includes a data management device configured to enable an operator to perform at least one of:
loading a set of default answers into a section of a questionnaire,
electronically importing a set of answers from a previous questionnaire, and
incorporating one or more independent files into questionnaire.

21. The apparatus of claim 19, wherein the computerized administrator further includes a flagging device capable of generating a flag based on one of an answer provided by an operator and a failure of an operator to provide an answer to a required question.

22. The apparatus of claim 1, wherein the computerized administrator further includes a communication device capable of directing electronic communication between an audit-administrator and an operator.

23. An electronic signal carried over a portion of the Internet, comprising:
one or more web-pages provided by a computerized administrator to a terminal located at a geographically distant site;
wherein the web-pages include one or more questionnaires directed to conducting a regulatory audit.

24. An apparatus for conducting a regulatory audit, comprising:
a storage means for storing one or more questionnaires directed to a regulatory audit;
an input/output means for providing the questionnaires over the Internet to a plurality of terminals located at a geographically distant sites from the storage means;
a data management means for compiling replies to the questionnaires, the replies being provided by operators using the plurality of terminals; and
a reporting means for generating a report based on the compiled replies.

25. A method for conducting a regulatory audit, comprising:
generating one or more questionnaires directed to a regulatory audit;
providing the questionnaires to a plurality of terminals over the Internet, the terminals being located at sites geographically distant from one another;
compiling replies to the questionnaires, the replies being provided by operators using the plurality of terminals; and
generating a report based on the compiled replies.

26. A storage medium that stores a plurality of instructions that, if executed, enables a networked processor-based system to:
provide a number of questionnaires directed to a regulatory audit from the processor-based system to a plurality of terminals over the Internet, the terminals being located at sites geographically distant from the processor-based system;
compile replies to the questionnaires, the replies being provided by operators using the plurality of terminals; and
generate a report based on the compiled replies.
